(19) United States
(12) Patent Application Publication
(10) Pub. No.: US 2023/0213698 A1
(43) Pub. Date: Jul. 6, 2023

(54) ULTRA-LOW LOSS OPTICAL FIBERS FOR LONG HAUL COMMUNICATIONS

(71) Applicant: Sterlite Technologies Limited, Haryana (IN)

(72) Inventors: Srinivas Reddy Munige, Haryana (IN); Apeksha Malviya, Haryana (IN); Anand Pandey, Haryana (IN)

(21) Appl. No.: 18/148,547

(22) Filed: Dec. 30, 2022

(30) Foreign Application Priority Data
Jan. 5, 2022 (IN) 202211000672

(51) Int. Cl. G02B 6/036; F21V 8/00; G02B 6/028

(52) U.S. Cl. CPC G02B 6/03638; G02B 6/0003; G02B 6/028; H04B 10/80

(57) ABSTRACT

The present invention relates to an ultra-low loss optical fiber for long haul communications (100) comprising a core region (102) defined by a core relative refractive index and a cladding region surrounding the core region, defined by a cladding relative refractive index. In particular, the core region comprises a relative refractive index in a range of −0.06% to +0.06% and the cladding region is down-doped for entire radial cladding thickness. Moreover, the cladding region further comprises an inner cladding region (104) defined by an inner cladding relative refractive index and an outer cladding region (106) defined by an outer cladding relative refractive index. The inner cladding relative refractive index is less than the outer cladding relative refractive index.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

This application claims benefit of Indian Patent Application No. 202211000972, entitled “ULTRA-LOW LOSS OPTICAL FIBERS FOR LONG HAUL COMMUNICATIONS” filed by the applicant on Jan. 5, 2022, which is incorporated by reference in its entirety.

### FIELD OF THE INVENTION

Embodiments of the present disclosure relate to the field of optical fiber and more particularly, relates to ultra-low loss optical fibers for long haul communications.

### BACKGROUND OF THE INVENTION

Telecommunications networks include access networks where end-user subscribers connect to service providers. With the advancement of science and technology, various modern technologies are being employed for communication purposes. One of the most important modern communication technologies is optical fiber communication technology using a variety of optical fibers.

Being a critical component of a modern communication network across the globe, optical fiber cables are widely used for communication to meet the increasing demands. Optical fiber cables utilize optical fibers to transmit signals such as voice, video, image, data or information. Optical fibers are strands of glass fiber processed so that light beams transmitted through the glass fiber are subject to total internal reflection wherein a large fraction of the incident intensity of light directed into the fiber is received at the other end of the fiber.

To provide improved performance to subscribers, fiber optic networks are increasingly providing optical fiber connectivity directly to the subscribers. As part of various fiber-to-the-premises (FTTP), fiber-to-the-home (FTTH), and other initiatives (generally described as FTTX), such fiber optic networks are providing the optical signals from distribution cables through local convergence points (“LCPs”) to fiber optic cables, such as drop cables, that are run directly to the subscribers' premises. Thus, installation of the optical fiber cables at a rapid pace has become essential.

Optical fibers are used to transmit information as light pulses from one end to another. One such type of optical fiber is a single mode optical fiber. Generally the two main categories of optical fibers are multimode fibers and single-mode fibers. In a multimode optical fiber, for a given wavelength, several optical modes are propagated simultaneously along the optical fiber, whereas in a single-mode optical fiber, the higher order modes are strongly attenuated. A single mode fiber is an optical fiber that is designed for the transmission of a single spatial mode of light as a carrier. This mode of light may contain a variety of different wavelengths, although the range of wavelengths that can be transmitted is a function of the diameter of the core of the fiber.

The telecommunications industry is continuously striving for designs to achieve high data rate capacity and low losses. Single-mode optical fibers that are compliant with the ITU-T G.652.D requirements are commercially available and the ongoing research suggests that the single mode optical fiber of G657 and G652D categories are used for the FTTx and long-haul applications. Currently, there are a few patent applications employing single mode fibers for the FTTx and long-haul applications.

US patent application no. U.S. Pat. No. 8,712,199B2 titled ‘Configurable pitch reducing optical fiber array” discloses at least one extending longitudinal waveguide comprising one of a standard single mode fiber, a standard multimode fiber, and a standard large mode area fiber.

US patent application no. U.S. Pat. No. 9,134,519B2 titled “Multi-mode fiber optically coupling a radiation source module to a multi-focal confocal microscope” discloses an optical fiber that may be a multi-mode fiber or a single mode fiber.

However, there are a number of drawbacks in the current technologies providing single mode fibers for the FTTx and long-haul applications. The single mode optical fiber of G652D and G657 categories discloses in the prior arts face major challenges in 400G transmission in territorial long haul communication systems due to non-linear effects that occur due to small effective area, higher attenuation and low SNR (Signal-to-Noise Ratio). Moreover, single mode fibers can only operate as such over a limited spectral range. Above a given upper cutoff wavelength the fiber is too small to transmit light. Below a lower cutoff wavelength, the light is no longer transmitted in a single mode.

Accordingly, to overcome the disadvantages of the prior arts, there is a need for a technical solution that overcomes the above-stated limitations in the prior arts. The present invention provides an ultra-low loss optical fiber for long haul communications.

### SUMMARY OF THE INVENTION

Embodiments of the present invention relates to an ultra-low loss optical fiber for long haul communications. In particular, the optical fiber comprises a core region defined by a core relative refractive index and a cladding region surrounding the core region, defined by a cladding relative refractive index. Moreover, the cladding region is down-doped for entire radial cladding thickness and the core region comprises a relative refractive index in a range of −0.06% to +0.06%. Further, the cladding region comprises an inner cladding region and an outer cladding region.

The inner cladding region is defined by an inner cladding relative refractive index and the outer cladding region is defined by an outer cladding relative refractive index. In particular, the inner cladding relative refractive index is less than the outer cladding relative refractive index. Moreover, the inner cladding relative refractive index ranges between −0.29% and −0.32% and the outer cladding relative refractive index ranges between −0.24% and −0.28%. Further, the inner cladding region is defined by an inner cladding radius ranging between 21 μm and 25 μm and the inner cladding relative refractive index ranging between −0.29% and −0.32% and the outer cladding region is defined by an outer cladding radius of 62.5±0.7 μm and the outer cladding relative refractive index ranging between −0.24% and −0.28%. The inner cladding relative refractive index is less than the outer cladding relative refractive index.

In accordance with an embodiment of present invention, the inner cladding region has a first fluorinated region T1 defined by a thickness r₂−r₁, which is a difference between the inner cladding radius and the core radius. The outer cladding region has a second fluorinated region T2 defined by a thickness r₃−r₂, which is a difference between the outer cladding radius and the inner cladding radius.

In accordance with an embodiment of present invention, the optical fiber is characterized by an attenuation of less than or equal to 0.17 dB/km at 1550 nm wavelength and an attenuation of less than or equal to 0.20 dB/km at 1625 nm wavelength and a mode field diameter (MFD) of 12.5±0.5 at 1550 nm wavelength. The optical fiber has a macro-bend loss of less than or equal to 0.1 dB per 100 turns at 30 mm radius and at 1625 nm wavelength and a macro-bend loss of less than or equal to 0.03 dB per 100 turns at 30 mm radius and at 1550 nm wavelength.

The foregoing objectives of the present invention are attained by employing ultra-low loss optical fibers for long haul communications.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description reference to the drawings, in which:

FIG. 1 is a snapshot illustrating a cross-sectional view illustrating an optical fiber in accordance with one embodiment of the present disclosure; and

FIG. 2 is a snapshot illustrating a refractive index profile of the optical fiber in accordance with one embodiment of the present disclosure.

### ELEMENT LIST

Optical fiber—100
Core region—102
Cladding region—104
Inner clad region—106
Outer clad region—108
Central longitudinal axis—110
Refractive index profile—200
Cable—300
Plurality of optical fiber bundles—302
Sheath—304

It should be noted that the accompanying figure is intended to present illustrations of exemplary embodiments of the present invention. This figure is not intended to limit the scope of the present invention.

It should also be noted that the accompanying figure is not necessarily drawn to scale.

### DETAILED DESCRIPTION OF THE PREFERRED EMBODIMENTS

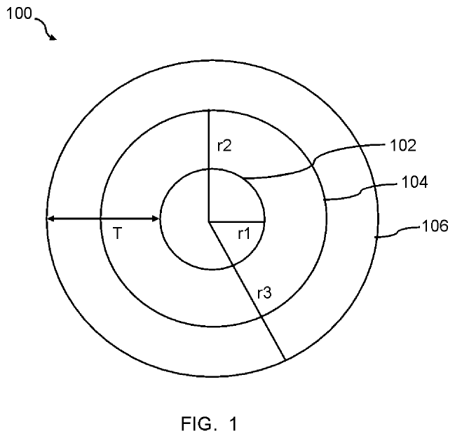

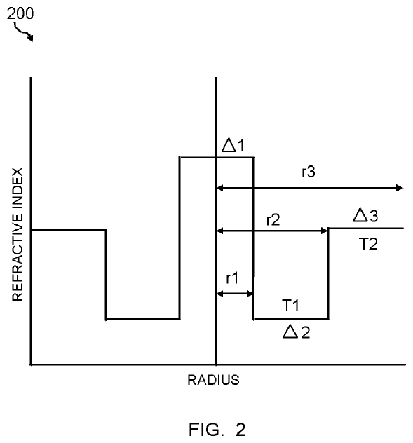

The principles of the present disclosure and their advantages are best understood by referring to FIG. 1 to FIG. 2. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present disclosure:

Optical fiber is a thin strand of glass or plastic or combination thereof capable of transmitting optical signals.

Relative refractive index is a measure of relative difference in refractive index between two optical materials.

Cut-off wavelength is a minimum wavelength in which the optical fiber acts as a single mode fiber and the chromatic dispersion is a phenomenon of optical signal spreading over time resulting from the different speeds of light rays.

Mode field diameter defines a section or area of optical fiber in which the optical signals travel.

Macro bend loss is defined by a loss occurred when an optical fiber cable is subjected to a significant amount of bending.

FIG. 1 is a snapshot illustrating a cross-sectional view of an ultra-low loss optical fiber in accordance with an embodiment of the present invention.

FIG. 2 illustrates a refractive index profile of the ultra-low loss optical fiber in accordance with an embodiment of the present invention.

Referring to FIG. 1 and FIG. 2., the optical fiber 100 is configured to transmit information over long distances with low non-linear effects. In particular, the optical fiber 100 may include a core region 102 and a cladding region. Moreover, the core region 102 may be formed by pure silica (aka “silica”). Further, the core region 102 may comprise a relative refractive index in a range of −0.06% to +0.06%. That is, the core region 102 may be the pure silica or the core region 102 may be up-doped or the core region 102 may be down-doped. The up-doping increases a refractive index of the silica, whereas the down-doping lowers the refractive index of the silica.

In accordance with an embodiment of the present invention, the dopant may be, but not limited to, germanium oxide (GeO2), fluorine, boron, chlorine, phosphorus. Preferably, the dopant is germanium oxide (GeO2).

The core region 102 may be defined by a core relative refractive index Δ1 and a core radius r1. The value of the core relative refractive index Δ1 may be between −0.06% and 0.06% depending upon doping of the core region 102 and the core radius r1 may be between 6.1 μm and 6.5 μm. Preferably, the value of the core relative refractive index Δ1 may be zero (0) and the core radius r1 may be 6.4 μm. Alternatively, the value of the core relative refractive index Δ1 and the core radius r1 may vary.

In accordance with an embodiment of the present invention, the core region 102 may be surrounded by the cladding region. In particular, the cladding region may be defined by a cladding relative refractive index and a cladding radius. Moreover, the cladding region may comprise an inner cladding region 104 and an outer cladding region 106. Further, the inner cladding region 104 may be defined by an inner cladding relative refractive index 42 and an inner cladding radius r2.

The outer cladding region 106 may be defined by an outer cladding relative refractive index Δ3 and an outer cladding radius r3. The inner cladding relative refractive index Δ2 may be less than the outer cladding relative refractive index Δ3. In particular, the value of the inner cladding relative refractive index Δ2 may be between −0.29% and −0.32% and the inner cladding radius r2 may be between 21 μm and 25 μm. Preferably, the value of the inner cladding relative refractive index Δ2 may be −0.30% and the inner cladding radius r2 may be 22 μm. Similarly, the value of the outer cladding relative refractive index Δ3 may be between −0.24% and −0.28% and the outer cladding radius r3 may be 62.5+0.7 μm. The value of the outer cladding relative refractive index Δ3 may be −0.26% and the outer cladding radius r3 may be 62.5 μm. Alternatively, the value of the outer cladding relative refractive index Δ3 and the outer cladding radius r3 may vary.

In accordance with an embodiment of the present invention, the cladding region may be doped with a down-dopant, such as fluorine, for entire radial cladding thickness (T). Alternatively, other down-dopants (known to a person skilled in the art) may be used. The down-dopant has a propensity to lower the refractive index of the silica. Accordingly, the cladding region may have a fluorinated region. That is, the inner cladding region 104 may have a first fluorinated region T1 defined by a thickness r₂−r₁(i.e., difference between the inner cladding radius and the core radius) and the outer cladding region 106 may have a second fluorinated region T2 defined by a thickness r₃−r₂ (i.e., difference between the outer cladding radius and the inner cladding radius). The first fluorinated region T1 and the second fluorinated region T2 may extend radially outwards from the core region 102.

In accordance with an embodiment of the present invention, the fluorinated cladding region with the fluorinated region and lower or no doping of GeO2 in the core region result in the optical fiber 100 having the large effective area and mode field diameter (MFD), reduced non-linear effects, low attenuation, low latency, higher OSNR as compared to G652D.

In accordance with an embodiment of the present invention, the optical fiber 100 may be characterized by an attenuation of less than or equal to 0.17 dB/km at 1550 nm wavelength and an attenuation of less than or equal to 0.20 dB/km at 1625 nm wavelength, a cable cut-off wavelength of less than or equal to 1530 nm and a chromatic dispersion (CD) ranging between 17 picosecond/(nanometer-kilometer) and 23 picosecond/(nanometer-kilometer) at 1550 nm wavelength and less than or equal to 27 picosecond/(nanometer-kilometer) at 1625 nm wavelength. Further, the optical fiber 100 may have a dispersion slope in a range between 0.05-0.07 ps/nm²-km and an MFD of 12.5±0.5 μm at 1550 nm wavelength. Furthermore, the optical fiber 100 may have a macro-bend loss of less than or equal to 0.1 dB per 100 turns at 30 mm radius and at 1625 nm wavelength and a macro-bend loss of less than or equal to 0.03 dB per 100 turns at 30 mm radius and at 1550 nm wavelength.

Advantageously, the ultra-low loss optical fiber for long haul communications having an optimize design with a large effective area and mode field diameter (MFD), reduced non-linear effects, a low attenuation, a low latency, a high OSNR (Optical Signal to Noise Ratio) as compared to G652D optical fiber.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

We claim:

1. An optical fiber (100), comprising:
a core region (102) defined by a core relative refractive index; and
a cladding region surrounding the core region (102), wherein the cladding region is down-doped for entire radial cladding thickness;
wherein the optical fiber (100) is an ultra-low loss optical fiber (100).

2. The optical fiber (100) as claimed in claim 1, wherein the core region (102) comprises a relative refractive index in a range of −0.06% to +0.06%.

3. The optical fiber (100) as claimed in claim 1, wherein the cladding region further comprising an inner cladding region (104) and an outer cladding region (106)

4. The optical fiber (100) as claimed in claim 3, wherein the inner cladding region (104) is defined by an inner cladding relative refractive index.

5. The optical fiber (100) as claimed in claim 3, wherein the outer cladding region (106) is defined by an outer cladding relative refractive index.

6. The optical fiber (100) as claimed in claim 3, wherein the inner cladding relative refractive index is less than the outer cladding relative refractive index.

7. The optical fiber (100) as claimed in claim 3, wherein the inner cladding region (104) has a first fluorinated region T1 defined by a thickness r₂−r₁, which is a difference between an inner cladding radius and a core radius.

8. The optical fiber (100) as claimed in claim 3, wherein the outer cladding region (106) has a second fluorinated region T2 defined by a thickness r₃−r₂, which is a difference between an outer cladding radius and the inner cladding radius.

9. The optical fiber (100) as claimed in claim 5, wherein the thickness of the first fluorinated region T1 is less than the thickness of the second fluorinated region T2.

10. The optical fiber (100) as claimed in claim 3, wherein the inner cladding region (104) is defined by an inner cladding radius ranging between 21 μm and 25 μm.

11. The optical fiber (100) as claimed in claim 3, wherein an inner cladding relative refractive index ranging between −0.29% and −0.32%.

12. The optical fiber (100) as claimed in claim 3, wherein the outer cladding region (106) is defined by an outer cladding radius ranging between 61.8 μm to 63.2 μm

13. The optical fiber (100) as claimed in claim 3, wherein an outer cladding relative refractive index ranging between −0.24% and −0.28%.

14. The optical fiber (100) as claimed in claim 1, wherein the optical fiber (100) is characterized by an attenuation of less than or equal to 0.17 dB/km at 1550 nm wavelength.

15. The optical fiber (100) as claimed in claim 1, wherein the optical fiber (100) is characterized by attenuation of less than or equal to 0.20 dB/km at 1625 nm wavelength.

16. The optical fiber (100) as claimed in claim 1, wherein the optical fiber (100) is characterized by a mode field diameter (MFD) of 12.5±0.5 at 1550 nm wavelength.

17. The optical fiber (100) as claimed in claim 1, wherein the optical fiber (100) has macro-bend loss of less than or equal to 0.1 dB per 100 turns at 30 mm radius and at 1625 nm wavelength.

18. The optical fiber (100) as claimed in claim 1, wherein the optical fiber (100) has macro-bend loss of less than or equal to 0.03 dB per 100 turns at 30 mm radius and at 1550 nm wavelength.

19. The optical fiber (100) as claimed in claim 1, wherein the optical fiber (100) has a dispersion slope in a range between 0.05-0.07 ps/nm²-km.

20. The optical fiber (100) as claimed in claim 1, wherein the cladding region (104) is doped with a down-dopant.
